(19) United States
(12) Patent Application Publication
(10) Pub. No.: US 2026/0362219 A1
(43) Pub. Date: Nov. 12, 2026

(54) METHODS FOR DYNAMIC SSC MODE HANDLING

(71) Applicant: InterDigital Patent Holdings, Inc., Wilmington, DE (US)

(72) Inventors: Jung Je Son, Warrington, PA (US); Anuj Sethi, Ottawa (CA); Guanzhou Wang, Brossard (CA); Samir Ferdi, Kirkland (CA); Taimoor Abbas, Sainte-Julie (CA)

(73) Assignee: InterDigital Patent Holdings, Inc., Wilmington, DE (US)

(21) Appl. No.: 19/202,495

(22) Filed: May 8, 2025

(51) Int. Cl. H04W 28/02; H04W 76/10; H04W 76/30

(52) U.S. Cl. CPC H04W 28/0268; H04W 76/10; H04W 76/30

(57) ABSTRACT

A WTRU sends, to SMF1, a PDU session establishment request for a DNN with dynamic SSC mode indication. The WTRU receives a PDU session establishment accept for the DNN with dynamic SSC mode indication per QoS flow and data is exchanged for all QoS flows using the PDU session. The WTRU may receive, from SMF1, a PDU session modification command for PDU session reallocation with QoS flows for requested SSC mode handling and deletes QoS flows for SSC mode 2 handling from the PDU session. The WTRU sends, to SMF1, a PDU session modification complete and sends, to SMF2, a PDU session establishment request for the DNN for PDU session reallocation. The WTRU receives, from SMF2, a PDU session accept for the DNN for PDU session reallocation and deletes QoS flows for SSC mode 3 from the PDU session with SMF1 after a timer expires. Additional embodiments are disclosed.

### BACKGROUND

Session and service continuity (SSC) mode handling in the 5G network (NW) presents certain drawbacks. With SSC mode 1, the network preserves the connectivity service provided to the user equipment (UE) and for the case of PDU session of an Internet Protocol (IP)v4 or IPv6 or IPv4v6 type, the IP address is preserved. With SSC mode 2, the network may release the connectivity service delivered to the UE and release the corresponding PDU session(s). In the case of IPv4 or IPv6 or IPv4v6 type, the release of the PDU session induces the release of IP address(es) that had been allocated to the UE. With SSC mode 3, changes to the user plane can be visible to the UE, while the network ensures that the UE suffers no loss of connectivity. A connection through a new PDU session anchor point is established before the previous connection is terminated in order to allow for better service continuity. In the case of IPv4 or IPv6 or IPv4v6 type, the IP address is not preserved in this mode when the PDU session anchor changes. SSC mode selection is based on NW configuration and the SSC mode is never changed during life time of protocol data unit (PDU) session. This static nature of SSC mode may not be adequate to adapt to the dynamic traffic characteristics of virtual reality (VR), augmented reality (AR) or metaverse service.

Current SSC mode selection requires establishment of different PDU session for different SSC modes with the same data network name (DNN) and this may require additional overhead managing multiple PDU sessions for a given application. However, as the PDU session changes take place based on UE's mobility, for some time, PDU sessions will not require the change of the PDU session anchor (i.e., user plane function UPF) at all during life time of PDU session. A SSC mode selection policy is used to allow for UE to select a SSC mode for an application and requires additional procedures for configuring and updating the SSC mode selection policy. However, as the session management function (SMF) in the network has final decision, based on configured information within the system and subscription data, the UE's choice on the SSC mode selection per SSC mode selection policy may not be accepted. In this case, the PDU session establishment request will be rejected. Accordingly, solutions are desired to enhance the current handling of session and service continuity to support various service characteristics in more efficient and flexible manners.

### SUMMARY

On or more of the foregoing issues may addressed by a first aspect of the disclosure which provides dynamic SSC mode indication. In an example a first SMF (SMF1) may be configured with dynamic SSC mode indication for each allowed application per DNN. The SMF1 may receive, from a UE, alternatively referred to herein as a wireless transmit/receive unit (WTRU), a PDU session establishment request for a DNN with dynamic SSC mode indication. SMF1 may authorize the PDU session establishment request based on the WTRU subscription data for the requested DNN and requested dynamic SSC mode indication. Once authorized, SMF1 may assign quality of service QoS flows for the requested DNN based on policy and store mapping with each QoS flow and allowed SSC mode per allowed application at the QoS flow as session management (SM) context. SMF1 may send, to the WTRU, a PDU session establishment accept including QoS flows and QoS parameters allowed for the DNN and register SMF1 information as WTRU's serving SMF for the requested DNN in the unified data management (UDM). When SMF1 detects a need requiring the PDU session anchor (PSA) change (i.e., the UPF changes), SMF1 may send a PDU session modification command indicating PDU session reallocation with QoS flows to be moved to a new PSA/UPF with requested SSC mode handling. SMF1 receives, from the WTRU, a PDU session modification complete, SMF1 provides SM context for the WTRU with the requested DNN to the target SMF (SMF2) and release the PDU session after QoS flows are released.

In another aspect, the target SMF (SMF2) may be configured with SSC mode handling for each allowed application per DNN. SMF2 receive, from the WTRU, a PDU session establishment request for a DNN with dynamic SSC mode indication and authorizes the PDU session establishment request based on the subscription data for the requested DNN and requested dynamic SSC mode indication. SMF2 retrieves the WTRU's old serving SMF information (here SMF1) for the requested DNN and receives SM context from SMF1. SMF2 assigns QoS flows for the requested DNN based on policy and SM context received which are applicable for the PDU session reallocation and stores mapping with each QoS flow and allowed SSC mode per allowed application at the QoS flow as SM context. SMF2 sends, to the WTRU, a PDU session establishment accept including QoS flows and QoS parameters allowed for the DNN. SMF2 registers SMF2 information as the WTRU's serving SMF for the requested DNN in the UDM.

In yet another aspect from the WTRU's perspective, the WTRU sends, to SMF1, a PDU session establishment request for a DNN with dynamic SSC mode indication. The WTRU receives a PDU session establishment accept for the DNN with allowed dynamic SSC mode indication per QoS flow and a first PDU session is established. The WTRU may then receive, from SMF1, a PDU session modification command for reallocation of QoS flows of the first PDU session based on the allowed dynamic SSC mode indication and deletes QoS flows associated with SSC mode 2 from the first PDU session. The WTRU sends, to SMF1, a PDU session modification complete and sends, to SMF2, a PDU session establishment request for reallocation of QoS flows from the first PDU session to a second PDU session based on associated SSC modes. The WTRU receives, from SMF2, a PDU session accept for the DNN for PDU session reallocation of QoS flows of the associated SSC modes and the second PDU secession is established. The WTRU deletes QoS flows associated with SSC mode 3 from the first PDU session with SMF1 a period of time after reallocation of those QoS flows to the second PDU session. Additional aspects, features or advantages may become apparent from the detailed embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating a simplified 5G system (5GS) architecture;

FIG. 3 is a functional block diagram illustrating a control plane (CP) stack between a WTRU and an access and mobility management function (AMF);

FIG. 4A is a network block diagram illustrating a method for dynamic session and service continuity (SSC) mode handling according to an example embodiment;

FIG. 4B is a continuation of the method for dynamic SSC mode handling of FIG. 4A;

FIG. 5 is a network block diagram illustrating a method for QoS flows determination for dynamic SSC mode handling based on session management (SM) context sharing according to an example embodiment;

FIG. 6 is a flow diagram illustrating a method for a WTRU using dynamic SSC mode 2 handling according to an example embodiment;

FIG. 7 is a flow diagram illustrating a method for a first session management function (SMF1) using dynamic SSC mode indication according to an example embodiment; and

FIG. 8 is a flow diagram illustrating a method for a second session management function (SMF2) using dynamic SSC mode indication according to an example embodiment.

### DETAILED DESCRIPTION

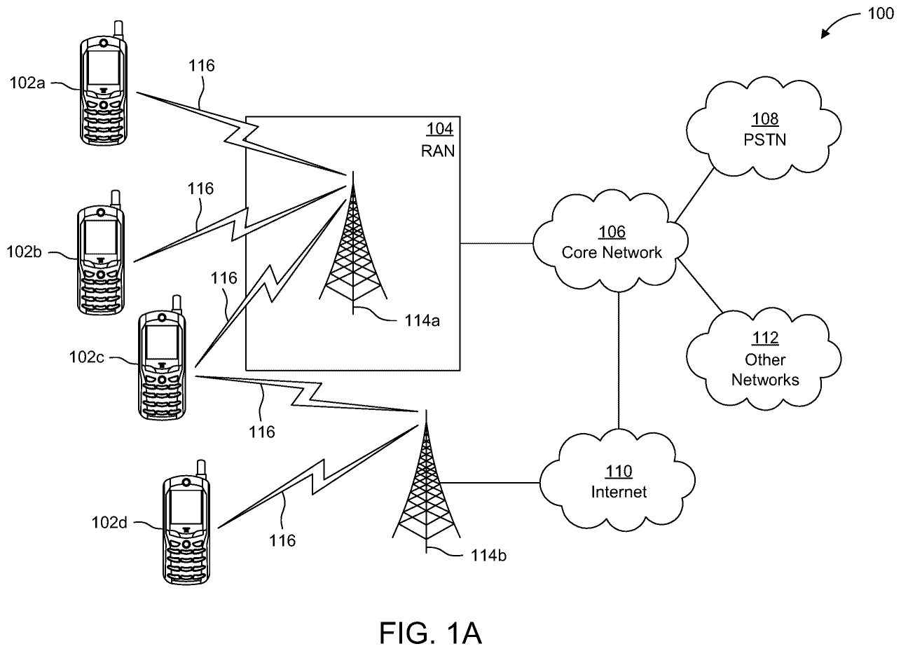

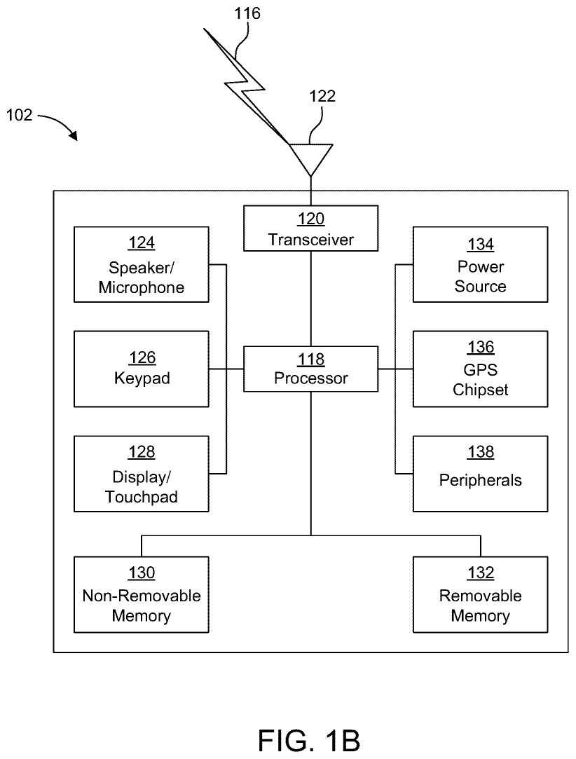

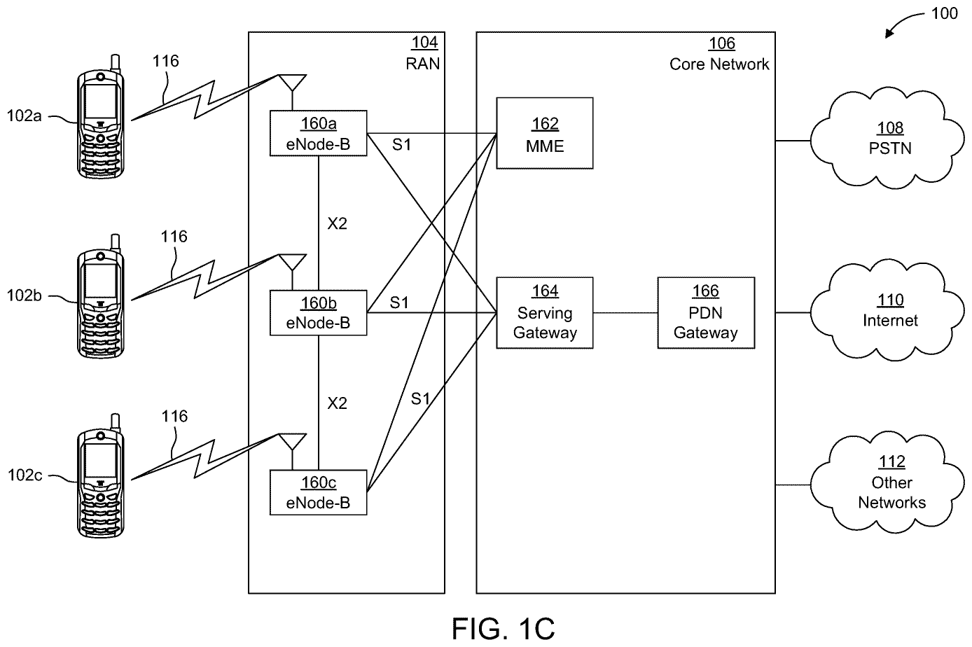

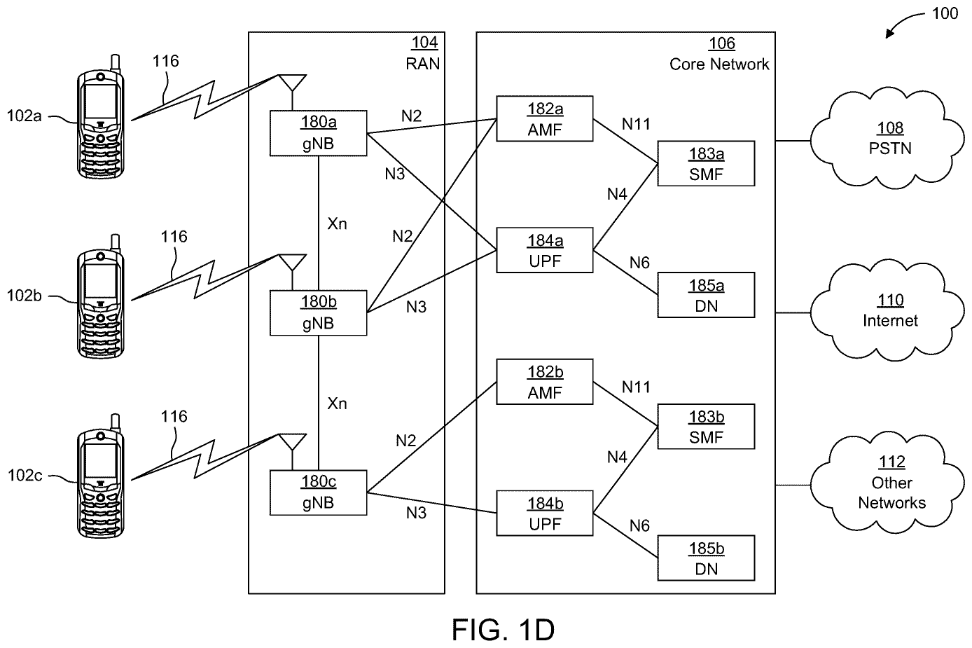

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

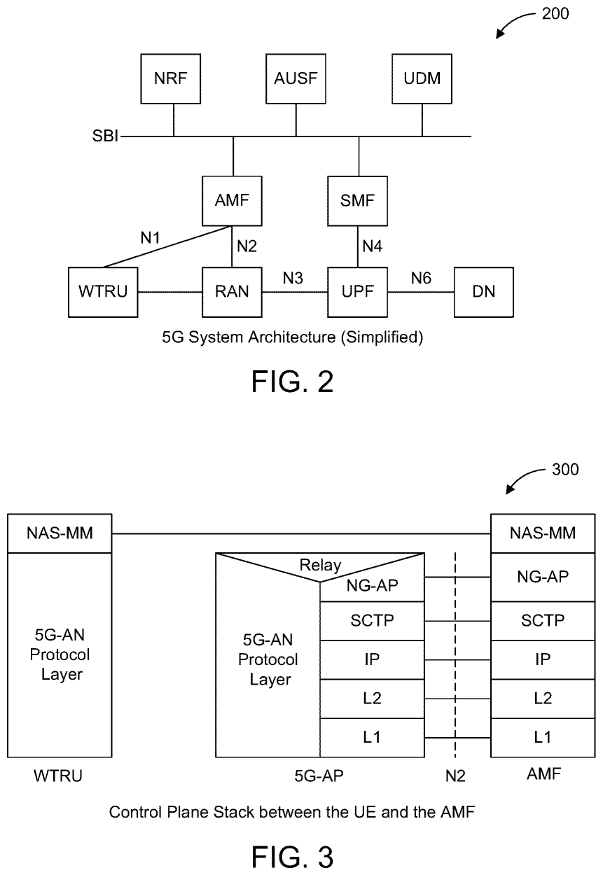

Referring to FIG. 2, a simplified version of the 5G System (5GS) service based architecture (SBA) 200 is shown where only a subset of the network functions (NFs) in the 5G Core are represented. The NFs (e.g., access and mobility management function (AMF), session management function (SMF), unified data management (UDM)) communicate with each other using a service based interface (SBI) (e.g., using protocols like hypertext transfer protocol (HTTP)). A goal of the SBA is to enable NFs to expose services (e.g., using RESTful APIs) to other NFs, for the system to provide the desired functionality. The other interfaces (Nx) shown in FIG. 2 and described below are different from the SBI.

The WTRU communicates with AMF over N1 using a non-access stratum (NAS) protocol. Control plane messaging between the WTRU and other NFs (e.g., SMF) is done using a NAS transport encapsulation mechanism provided by the AMF for the NFs.

As illustrated in FIG. 3, the 5G-Access Network (RAN) communicates with the AMF over N2 using a next generation application protocol (NGAP). Control plane messaging between the WTRU and RAN (using the Access Stratum (AS)) is done using radio resource control (RRC) (top of the 5G-AN Protocol layers) which is used to transport NAS messages received or sent by RAN over N2.

Session and service continuity (SSC) for 5GS is now described. The 5GS architecture supports the service and session continuity of IP traffic for the WTRU's application(s). As previously mentioned, presently, the SSC mode associated with a PDU session does not change during the lifetime of a PDU session.

There are three modes specified in 5GS:
SSC mode 1, in which the network preserves the connectivity service provided to the WTRU. For the case of PDU session of IPv4 or IPv6 or IPv4v6 type, the IP address is preserved.
SSC mode 2, in which the network may release the connectivity service delivered to the WTRU and release the corresponding PDU session. For the case of IPv4 or IPv6 or IPv4v6 type session, the release of the PDU session induces the release of IP address(es) that had been allocated to the WTRU.
SSC mode 3, in which changes to the user plane can be visible to the WTRU, while the network ensures that the WTRU suffers no loss of connectivity. A connection through a new PDU session anchor point/user plane function is established before the previous session connection is terminated in order to allow for better service continuity. For the case of IPv4 or IPv6 or IPv4v6 session type, the IP address is not preserved in SSC mode 3 when the PDU session anchor (PSA/UPF) changes.

With SSC mode 3, after the new IP address/prefix has been allocated, the old IP address/prefix is maintained during some time indicated to the WTRU and then released.

When a PDU session establishment is requested, the SMF selects a SSC mode for the PDU session based on the allowed SSC modes in the user subscription as well as the PDU session type, and if present, the SSC mode requested by the WTRU. The WTRU may be provisioned with a SSC mode selection policy (SSCMSP) as part of the UE route selection policy (URSP) rule. The WTRU shall use the SSCMSP to determine the type of session and service continuity mode associated with an application. If the WTRU does not have a SSCMSP, the WTRU can select a SSC mode based on a WTRU local configuration. If the WTRU cannot select a SSC mode, the WTRU requests the PDU session establishment without indication of the SSC mode.

If the SMF does not accept a requested SSC mode, the SMF may reject the PDU session establishment request. If the SSC mode is not indicated in the PDU session establishment request, the SMF selects the SSC mode.

The Next Generation Network architecture (e.g., 6G) is expected to continue and push further the shift started in 5G to embrace a cloud native implementation in the Core Network (CN). The push to bring core network user plane and other functions always closer to the edge will continue to be motivated by the need to support ever increasing traffic levels and lower latencies (e.g., XR, meta-verse, artificial intelligence/machine learning (AIML)). With this major trend the possibility to extend the SBA to the RAN emerges to simplify the network architecture while taking advantage of cloud native and micro-services architectures capabilities (e.g., scalability, elasticity, open interfaces).

For example, new architecture proposals are emerging with the possibility to extend the SBI framework beyond the 5GC NFs (as shown in FIG. 2). For example, a WTRU may use an evolved NAS mechanism to exchange NAS messages directly with one or more NFs, rather than through the AMF. As an example, a SBI compliant WTRU may establish an application layer communication directly with an NF (e.g., SMF) without going through AMF (i.e., instead of via N1).

In another trend, the next generation network is touted as bringing about the so called “connected intelligence” where intelligent networks using AIML technology will be able to connect a multitude of “intelligent” things. With huge amount of data collection from a multitude of devices (e.g., sensors, Ambient IoT) and with the added high flexibility and adaptability of AIML enabled functionalities, the system will pave the way for new advanced applications such as extended reality (XR)/Metaverse.

The Non-Access Stratum (NAS) protocol refers to a layer of communication protocols used between the WTRU and the access and mobility management function (AMF) located in the Core Network (CN) in the 5G core. The NAS protocol operates above the Access Stratum (AS) and plays a key role in managing signaling for mobility and session management. Different mobile network functions are based on the NAS protocol; examples of mobile network functions based on the NAS protocol are described hereafter.

A first function based on the NAS protocol is Mobility Management (MM). The NAS protocol enables to manage location updates as the WTRU moves between tracking areas (TAs) and includes procedures like initial registration, deregistration, and connection management.

A second function based on the NAS protocol is Session Management (SM). The NAS protocol enables to establish, modify, and release Protocol Data Unit (PDU) sessions for data transmission and support Quality of Service (QoS) management for applications.

A third function based on the NAS protocol is security management. The NAS protocol enables to provide mutual authentication between the WTRU and the Core Network (CN) network and facilitate encryption and integrity protection for NAS messages.

A fourth function based on the NAS protocol is paging coordination. The NAS protocol enables re-establishing communications with the WTRU when in idle mode.

A fifth function based on the NAS protocol is support for 5GS features. The NAS protocol enables slicing support, allowing the WTRU to connect to specific network slices based on service requirements, and enables managing dual connectivity and mobility across heterogeneous networks.

It can be appreciated that in 5G systems, the NAS protocol does not offer support for data collection and data collection session triggering or management. The NAS protocol ensures efficient and secure communication between the WTRU and the 5GC by supporting features and functions expected in 5G networks. Examples of supported functions include secure and encrypted communications, mobility support, session management, scalability (e.g., large number of devices), QoS differentiation, etc. The NAS protocol may be extended beyond 5G networks i.e. 6G mobile wireless system, with some modifications and enhancements on the WTRU side as well as on the 6G core network side.

The 5GC supports a PDU connectivity service, i.e., a service that provides exchange of PDUs (Protocol Data Units) between a WTRU and a data network identified by a DNN (Data Network Name). The PDU connectivity service is supported via PDU sessions that are established upon request from the WTRU between the WTRU and the 5GC. PDU sessions are established (upon WTRU request), modified (upon WTRU and/or 5GC network request) and released (upon WTRU and/or 5GC request) using NAS SM signalling exchanged over N1 between the WTRU and the SMF.

Current SSC mode handling in 5G NW presents some drawbacks. Session and Service continuity (SSC) mode selection is based on NW configuration and SSC mode is never changed during life time of PDU session. This static nature of SSC mode may not be adequate to adapt to the dynamic traffic characteristics of VR, AR, or metaverse service. For example, using a VR application, traffic for voice service may require SSC mode 1 handling (i.e., keeping the existing PDU session anchor (PSA/UPF) until voice call termination) for minimal service disruption, but video streaming may be ok with SSC mode 2 or SSC mode 3 handling. Therefore, it is desirable for such a VR application to be able to use a preferred SSC mode handling for some type of traffic, while using a different preferred SSC mode for some other type of traffic. Traffic pattern may also change per WTRU's status as foreground traffic (e.g., traffic generated based on user interaction and input such as real-time voice, video, etc.) or background traffic (e.g., traffic generated by application running in background without user interaction). For any traffic that requires SSC mode 1 or SSC mode 3 when transferred in the foreground, it may be sufficient to use SSC mode 2 when it runs as background traffic.

As previously mentioned, current SSC mode techniques require establishment of a different PDU session for each different SSC mode with the same DNN, which may require additional overhead managing multiple PDU sessions. However, as the PDU session change take place based on WTRU's mobility, for some time, PDU sessions will not require the change of PDU session anchor at all during life time of PDU session.

The SSC mode selection policy, which is used to allow for WTRU to select a SSC mode for an application, may require additional procedure for configuring and updating SSC mode selection policy. However, as the SMF has final decision based on configured information within the system and subscription data, the WTRU's choice on the SSC mode selection per SSC mode selection policy may not be accepted. In this case, the PDU session establishment request will be rejected. Therefore, it is desired to enhance the current handling of session and service continuity to support various service characteristics in more efficient and flexible manners.

Embodiments for Dynamic SSC mode indication are disclosed. As used herein, dynamic SSC mode indication refers to a PDU session in which more than one SSC mode is allowed for QoS flows for a DNN in a same PDU session. Dynamic SSC mode handling refers to treating QoS flows in the same PDU session based on each QoS flow and its associated allowed SSC mode.

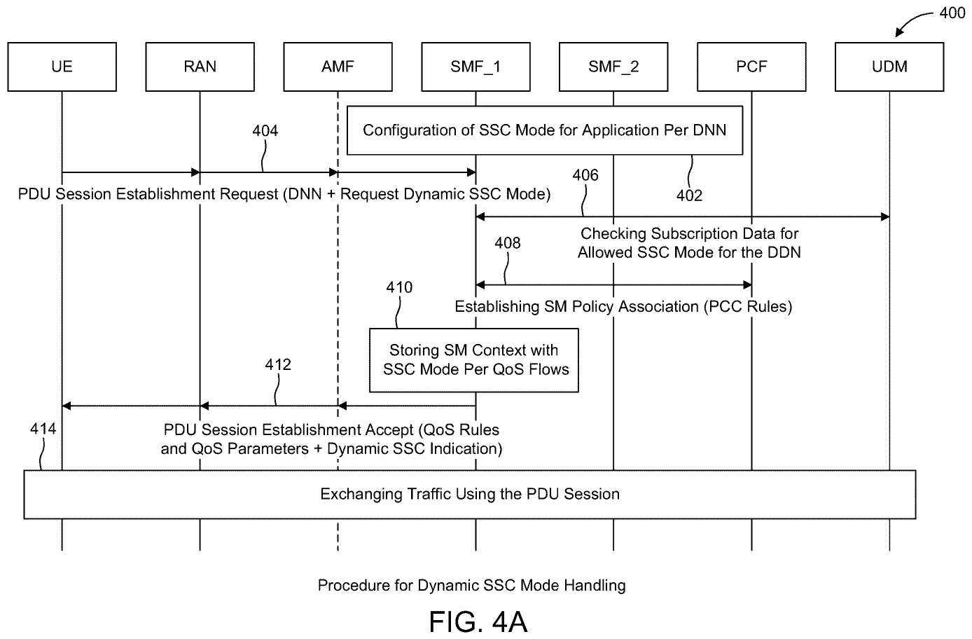

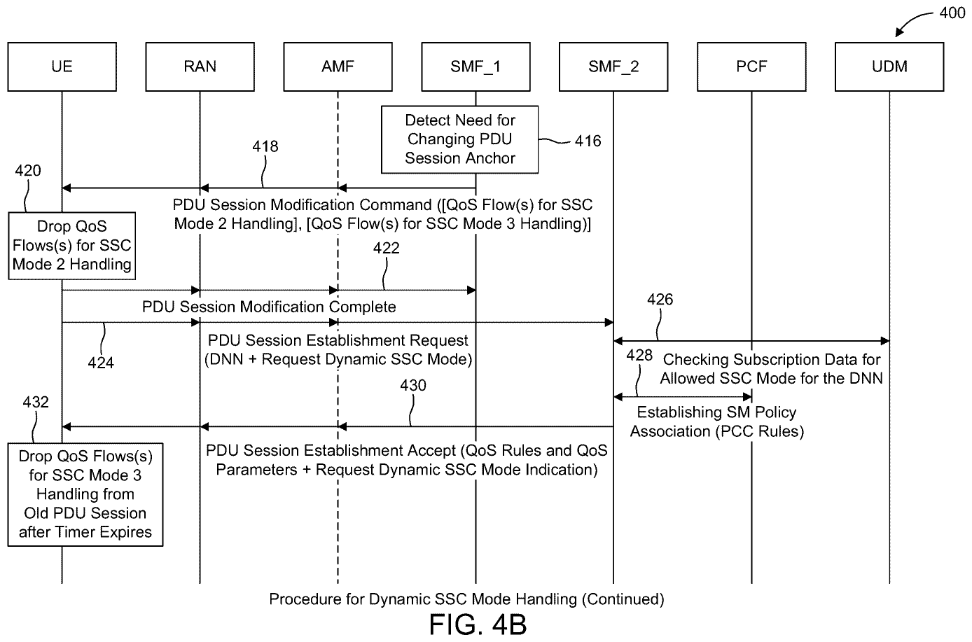

Referring to FIGS. 4A and 4B, a method 400 for dynamic SSC mode handling is shown according to an example embodiment. Entities involved in example method 400 may include a UE/WTRU, a radio access network (RAN) node, potentially an AMF, SMF1, SMF2, a policy control function (PCF) and UDM.

FIG. 4A method 400 includes 402, where the SMFs (SMF1, SMF2) are configured with SSC modes to be supported for the allowed applications for each DNN. (e.g., [DNN, allowed Application ID, supported SSC mode(s)]). As another embodiment, the configuration may be provided by the policy control function (PCF) during SM policy association in 408.

At 404, the WTRU may send a PDU session establishment request for a DNN with indication of dynamic SSC mode. Based on the DNN information, the RAN node may select a proper SMF (here SMF1) and send the PDU session establishment request to the selected SMF (SMF1), or as another embodiment, it may be sent to the AMF and the AMF may select a proper SMF and send the request to the selected SMF.

At 406, after receiving a PDU session establishment with a requested DNN with indication of dynamic SSC mode, SMF1 may verify whether the WTRU is allowed a PDU session for the DNN and whether the WTRU is allowed to use dynamic SSC mode indication by checking the subscription data of the WTRU from UDM.

At 408, SMF1 may establish a session management (SM) policy association for the PDU session with the requested DNN. SMF1 may assign the allowed QoS flows for the requested PDU session based on policy and charging control (PCC) rules provided from the policy control function (PCF). When QoS flow(s) are assigned for an application, the supported SSC mode are associated to the QoS flows based on the configuration provided at 402.

At 410, SMF1 stores the SM context with SSC mode per QoS flow. As another embodiment, a QoS flow may include a supported application ID in the QoS flow and the supported SSC mode may be associated to the application ID. In this case, SMF1 may manage the SM context with SSC mode for each application ID and the QoS flows with supported application IDs.

After setting up the PDU session for dynamic SSC mode, SMF1 may subscribe the activity monitoring of application configured for SSC mode at the UPF. Based on the any activity change in application traffic pattern detected by the UPF, or based on analytic information on the traffic pattern, SMF1 may decide different SSC mode handling for a configured application of the DNN (e.g. changing from SSC mode 3 to SSC mode 2 if it is detected the traffic is handled in background or in dormant time).

At 412, SMF1 may send a PDU session establishment accept to the WTRU via the RAN node. In an alternative embodiment the PDU session establishment accept may be sent via the AMF. The PDU session establishment accept may include QoS rules and QoS parameters for the WTRU and the RAN node and it may include indication if dynamic SSC mode is allowed. At 414, using the PDU session, the WTRU may exchange uplink and downlink data.

Turning to FIG. 4B, method 400 continue at 416, SMF1 may detect a need for the PDU session anchor change for some traffic over the PDU session. (e.g., the current PSA/UPF cannot serve some of the WTRU's traffic at the WTRU's new location.)

At 418, SMF1 may send a PDU session modification command to the WTRU via the RAN node and optionally via the AMF. The PDU session modification command may include list of QoS flows for SSC mode handling based on different SSC modes. (e.g., [X-QoS flows, SSC mode 1], [Y-QoS flows, SSC mode 2], [Z-QoS flows, SSC mode 3]).

In this respect, QoS flows with SSC mode 1 handling implies that the WTRU may maintain the associated X-QoS flows at the current PDU session. QoS flows with SSC mode 2 handling implies that the WTRU needs to delete the Y-QoS flows for SSC mode 2 handling and request a PDU session reestablishment. QoS flows with SSC mode 3 handling implies that the WTRU needs to request PDU session establishment for moving the Z-QoS flows of SSC mode 3 to a new PDU session and delete the Z-QoS flows for SSC mode 3 at the current PDU session, e.g., after a timer expires. As another embodiment, SMF1 may inform the PCF that PDU session reallocation is needed for the WTRU with the DNN.

At 420, after receiving a PDU session modification command, the WTRU may remove/drop the QoS flows which are included in the PDU session modification command as SSC mode handling based on their indicated SSC mode 2. In an example, the RAN node may remove resources for those QoS flows.

At 422, the WTRU sends a PDU session modification complete to the SMF1. When some QoS flows are included as SSC mode 1 handling in the received PDU session modification command, the WTRU may use the PDU session with the SMF1 for life time of the QoS flows.

At 424, the WTRU may send a PDU session establishment request with the requested DNN and indication of dynamic SSC mode and it is delivered to the new SMF (here SMF2), which manages the new PDU session. After receiving a PDU session establishment request, the RAN node may discover the new SMF (SMF2) and send the request to the selected SMF. Alternatively, as another embodiment, the RAN node may send the PDU session establishment request to the WTRU's serving AMF, and the AMF may discover the new SMF and send the PDU session establishment request to the selected SMF (e.g., SMF2).

At 426, after receiving the PDU session establishment with a requested DNN with indication of dynamic SSC mode, SMF2 may verify whether the WTRU is allowed a PDU session at the DNN and WTRU is allowed to use dynamic SSC mode by checking subscription data of the WTRU from UDM.

At 428, SMF2 may establish a SM policy association with the PCF for the PDU session with the requested DNN of the WTRU and indication of dynamic SSC mode. The PCF may verify whether there is existing SM policy association for the WTRU and the requested DNN. After the PCF detects SMF1 is maintaining the PDU session for the WTRU and the requested DNN, the PCF may detect this PDU session request is for PDU session reallocation and the PCF may inform the SMF2 that QoS flows with SSC mode 2 and SSC mode 3 handling need to be established as the initial PDU session is for PDU session reallocation.

As another embodiment, when the PCF receives the indication of PDU session reallocation from SM1 at 418, the PCF may determine the requested PDU session is for PDU session reallocation.

As another embodiment, the WTRU may include indication of PDU session reallocation in the PDU session establishment request in 424, and based on the indication, SMF2 may detect the PDU session request is for PDU session reallocation and may assign only QoS flows for SSC mode 2 handling and QoS flows for SSC mode 3 handling. When QoS flow(s) are assigned for an application, the supported SSC mode are associated to the QoS flows based on the configuration provided at 416.

At 430, SM_2 may send a PDU session establishment accept to the WTRU via the RAN node. In the alternative embodiment the PDU session establishment accept may be sent via the AMF. The PDU session establishment accept may include QoS rules and QoS parameters for the WTRU and the RAN node and it may include indication if dynamic SSC mode is allowed. In an example, the RAN node and SMF2 may exchange further signalling for establishing an N3 tunnel for the new PDU session. After receiving a PDU session establishment accept, the WTRU may send and receive data for the QoS flows with SSC mode 2 and SSC mode 3 with the newly established PDU session.

At 432, the WTRU may delete SSC mode 3 QoS flows from the old PDU session, e.g., after a timer expires from the PDU session modification command received in 418. When some QoS flows are included as SSC mode 1 handling in the received PDU session modification command in 418, the WTRU may continue to use the old PDU session with SMF1 for life time of those QoS flows. The old PDU session may be released when QoS flows for SSC mode 1 and SSC mode 3 handling are released.

Embodiments for dynamic SSC mode handling using SM context sharing between the old SMF and the new SMF are disclosed.

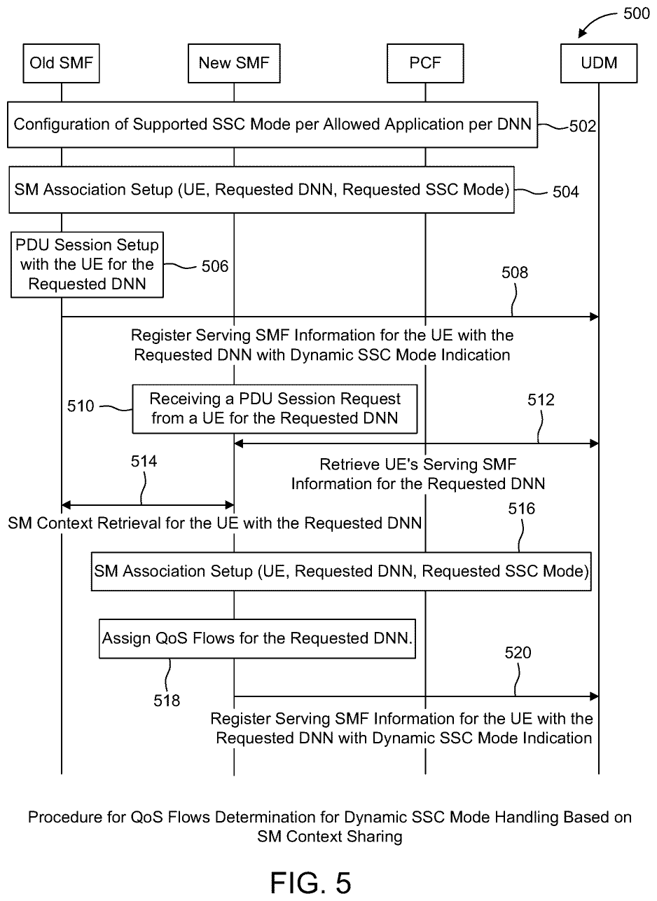

Referring to FIG. 5, a method 500 for QoS flow determination for dynamic SSC mode handling based on SM context sharing is shown according to an example embodiment. Entities involved in method 500 may include the old SMF (e.g., SMF1), the new SMF (e.g., SMF2), a PCF and UDM. At 502, the PCF may be configured with SSC modes to be supported for the allowed applications for each DNN (e.g., [DNN, allowed Application ID, supported dynamic SSC mode(s)]).

At 504, after receiving a PDU session setup request from a WTRU with the requested DNN, the old SMF may setup a SM association with the PCF for the WTRU with the requested DNN and requested dynamic SSC mode indication (e.g., dynamic SSC mode indication). As a response, the PCF may provide PCC rules for the requested DNN and SMF may assign QoS flows for the DNN based on PCC rules. When supported SSC mode of applications for the DNN are configured at the PCF, the PCF may provide the supported SSC mode for allowed application for the DNN.

The old SMF may assign QoS flow for the allowed application for the DNN and the old SMF may store the SM context with SSC mode per QoS flows. As another embodiment, a QoS flow may include supported application ID in the QoS flow and the supported SSC mode may be associated to the application ID. In this case, the old SMF may manage SM context with SSC mode for each application ID and QoS flows with supported application IDs.

In an example, based on user traffic pattern, network situation, policy, etc., old SMF may decide different SSC mode handling than the one provided by the PCF or the one preconfigured with the WTRU. When the old SMF receives the SSC mode configuration for an application, the old SMF may notify the PCF the differently assigned SSC mode handling information for the application to the PCF so that the PCF may update the application interaction or charging policy, etc.

At 506, the old SMF may send a PDU session establishment accept with the assigned QoS flows for the requested DNN to the WTRU. At 508, the old SMF may register its information as the WTRUs serving SMF for the requested DNN with the dynamic SSC mode indication.

At 510, the new SMF may receive a PDU session setup request from the WTRU with the requested DNN and dynamic SSC mode indication. After receiving the PDU session setup request, at 512, the new SMF may retrieve the WTRU's serving SMF information for the requested DNN from the UDM. After finding the old SMF information which serves the WTRU's PDU session with the requested DNN and verify whether the old SMF supports dynamic SSC mode handling, at 514, the new SMF may contact the old SMF for SM context sharing for the requested DNN. The old SMF may provide SM Context to the new SMF for the WTRU's PDU session for the requested DNN and provide the QoS flows with associated SSC mode handling.

At 516, the new SMF may setup a SM association for the WTRU's PDU session with the requested DNN and the new SMF may receive the PCC rule from the PCF. At 518, the new SMF may determine QoS flows which need SSC mode 2 handling and/or SSC mode 3 handling based on the SM context from the old SMF at 514.

At 518, the new SMF may assign QoS flows for the requested PDU session with the requested DNN based on determined QoS flows list needs SSC mode 2 and SS mode 3 handling by the SM context from the old SMF at 514, and based on PCC rules from the PCF at 516. The new SMF may send a PDU session setup accept to the WTRU (not shown) including those QoS flows. The new SMF may store the SMF context with SSC mode per QoS flow.

At 520, the new SMF may register its information as the WTRUs serving SMF for the requested DNN with the dynamic SSC mode indication. In an example, when there is existing PDU session served by the old SMF (e.g., SMF1), the old SMF information is not removed at the UDM. After the PDU session is released at the old SMF, the old SMF information as WTRU's serving SMF for the requested DNN is removed at the UDM.

As another embodiment, in 516, the PCF may inform the old SMF information to the new SMF and the new SMF may retrieve SM context from old SMF based on the old SMF information from the PCF.

Examples of decision-based SSC mode handling per user activity are disclosed. When dynamic SSC mode handling is supported and the old SMF (e.g., SMF1) detected the need for PDU session anchor/UPF change, the SSC mode for each QoS flow may be determined by the system dynamically.

In one example, the system may determine QoS flows should be move to the new PDU session anchor and may determine to drop some QoS flows. In an example, this may be determined based on analytic information of WTRU′ usage pattern per time or location. For example, if it is analyzed that an application is only used at a fixed service area for some time or for some location, it may be handled as SSC mode 1 or may be dropped if the WTRU moves away from its current service area.

For example, based on user's activity, some QoS flows may be determined as background traffic. If a QoS flow is determined as background traffic, the system may determine the SSC mode handling of the QoS flows as SSC mode 2 or may drop the QoS flows when WTRU moves away from its current service area. (e.g. for reducing energy consumption.)

For each QoS flow, system may provide priority values which means the service and session continuity for the QoS flow shall be provided while WTRU moves from its current service area. Based on the priority values, system may determine which QoS flows shall be reestablished or may be removed/dropped.

Embodiments for dynamic SSC mode handling with SSC mode selection policy provisioning to the WTRU are disclosed. As another embodiment, dynamic SSC mode handling may be enabled while SSC mode selection policy is provisioned to the WTRU.

When WTRU and the system support dynamic SSC mode handling, it may be negotiated during PDU session setup procedure. In this case, a PDU session with dynamic SSC mode handling may support the traffic in the QoS flow without establishing different PDU session setup is not needed per SSC mode.

When SSC mode selection policy is provisioned to the WTRU, in the PDU session modification request to request PDU session reestablishment, SMF does not need to indicate QoS flows with requested SSC mode handling. WTRU may decide different QoS flow handling per the SSC mode selection policy and WTRU may release QoS flows for SSC mode 2 and after setting up PDU session with new PDU session anchor (PSA/UPF), the WTRU may release QoS flows for SSC mode 3 from old PDU session after timer expires.

Embodiments for dynamic SSC mode handling with indication of preferred SSC mode per QoS flow level are now described. As another embodiment, based on SSC mode selection policy, WTRU may indicate preferred SSC mode per QoS flow. At first WTRU may identify a QoS flow serving the intended applications and select preferred SSC mode for the application (e.g., as configured in the SSC mode selection policy or as configured in local configuration).

If WTRU is allowed to request preferred QoS flows in the PDU session establishment request, the preferred QoS flows with preferred SSC mode may be indicated. Otherwise, the WTRU may indicate the preferred SSC mode in the PDU session modification request. (e.g., for each allowed QoS flows, WTRU may include preferred SSC mode in the PDU session modification request)

The SMF may decide different SSC mode than the preferred SSC mode from the WTRU (e.g. based on network condition, policy, analytics information on user's usage pattern, etc.) and SMF may provide QoS flows with associated recommended SSC mode based on SMF's discretion.

If the SMF accepts the requested SSC mode indication for each allowed QoS flow, the SMF may indicate the acceptance in the PDU session establishment accept or in the PDU session modification accept. As another embodiment, the SMF may include the allowed QoS flows with allowed SSC mode in the PDU session establishment accept or in the PDU session modification accept.

In one example, when a signalling message for the PDU session reallocation is received, the WTRU may decide different QoS flow handling per the preferred SSC mode (if allowed by NW) or per allowed SSC mode (if configured by SMF) and WTRU may release QoS flows for SSC mode 2 handling and after setting up PDU session with new PDU session anchor, the WTRU may release QoS flows for SSC mode 3 handling from old PDU session after timer expires.

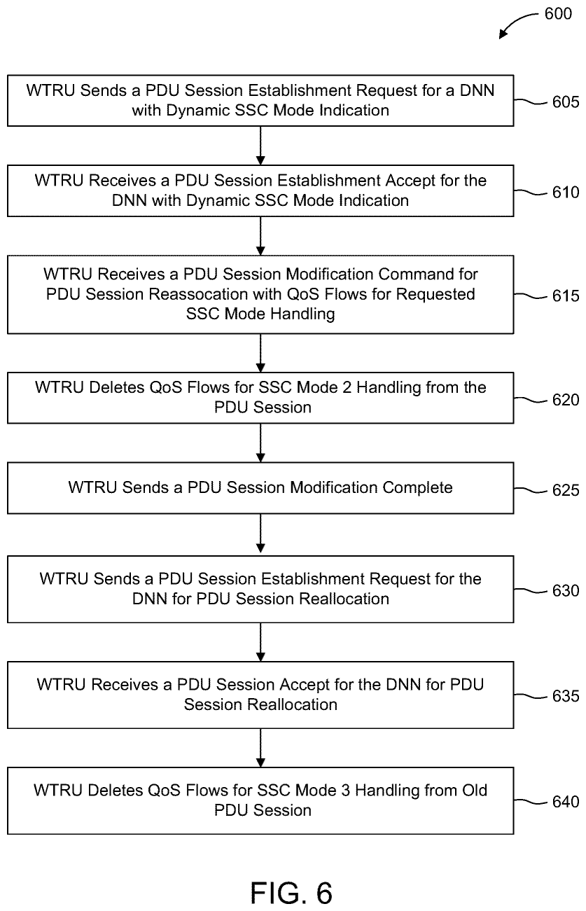

Referring to FIG. 6, a method 600 for a WTRU using dynamic SSC mode indication is shown according to an example embodiment. Method 600 includes a WTRU sending 605, to a first SMF (SMF1), a PDU session establishment request for a DNN with dynamic SSC mode indication. The WTRU receives 610 a PDU session establishment accept for the DNN with dynamic SSC mode indication per QoS flow. The WTRU exchanges data with the DN using the established PDU session.

The WTRU may receive 615, from SMF1, a PDU session modification command for PDU session reallocation with QoS flows for requested SSC mode handling and deletes 620 QoS flows for SSC mode 2 from the PDU session. The WTRU sends 625, to SMF1, a PDU session modification complete and sends 630, to SMF2, a PDU session establishment request for the DNN with dynamic SSC mode indication for PDU session reallocation. The WTRU receives 635, from SMF2, a PDU session accept for the DNN for PDU session reallocation and deletes 640 QoS flows for SSC mode 3 from the old PDU session with SMF1, e.g., after a timer expires.

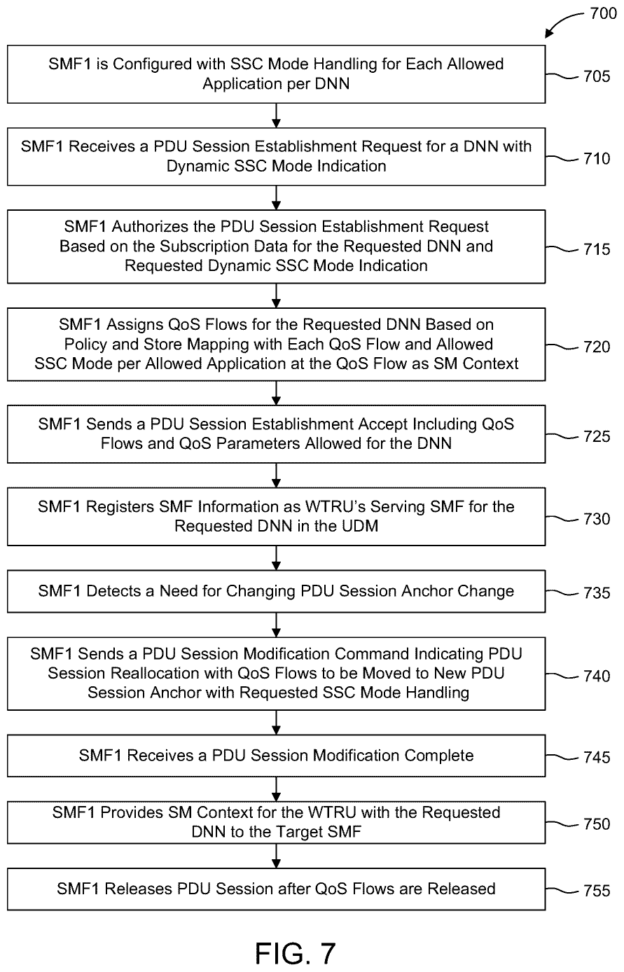

Referring to FIG. 7 a method 700 for a first session management function (SMF1) using dynamic SSC mode indication is shown according to an example embodiment.

In method 700, a first SMF (SMF1) may be configured 705 with dynamic SSC mode handling for each allowed application per DNN. The SMF1 may receive 710, from a WTRU, a PDU session establishment request for a DNN with dynamic SSC mode indication. SMF1 may authorize 715 the PDU session establishment request based on the WTRU subscription data for the requested DNN and dynamic SSC mode indication. Once authorized, SMF1 may assign 720 quality of service QoS flows for the requested PDU session and mapping allowed SSC modes per QoS flow and store the information as SM context. In an example, the assignment and mapping is based on policy from a PCF. SMF1 may send 725, to the WTRU, a PDU session establishment accept including QoS flows and QoS parameters including SSC modes allowed for the DNN, and register 730 SMF1 information as the WTRU's serving SMF for the requested DNN in the unified data management (UDM).

When SMF1 detects 735 a need requiring the PDU session anchor (PSA) change (i.e., the UPF changes based on WTRU mobility), SMF1 may send 740 a PDU session modification command indicating PDU session reallocation with QoS flows to be moved to a new PDU session based on the assigned SSC mode handling. SMF1 receives 745, from the WTRU, a PDU session modification complete, and SMF1 provides 750 SM context for the WTRU with the requested DNN to a target SMF (SMF2) and releases 755 the PDU session after QoS flows are released.

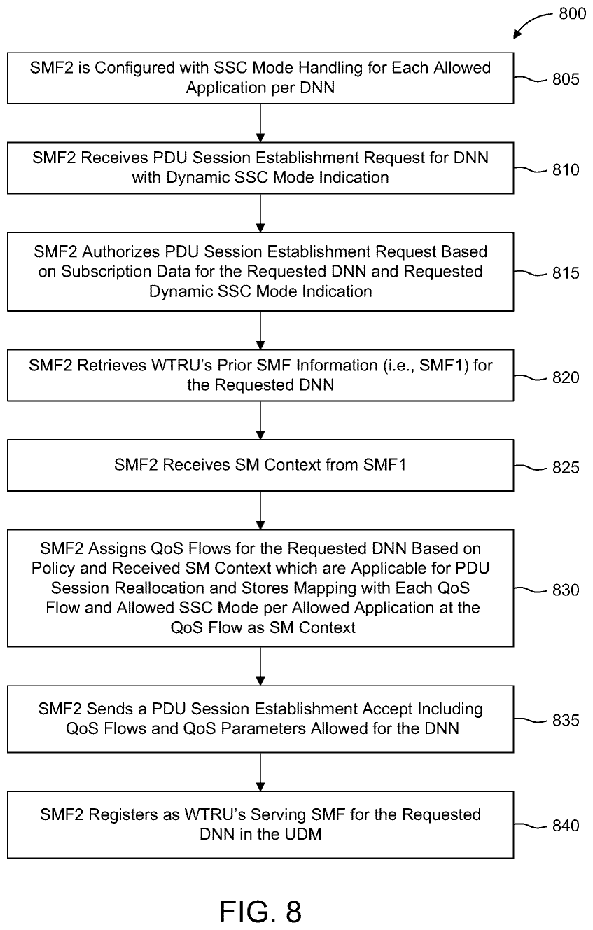

Referring to FIG. 8, a method 800 for a second session management function (SMF2) using dynamic SSC mode indication is shown according to an example embodiment.

The target SMF (SMF2) may be configured 805 with SSC mode handling for each allowed application per DNN. SMF2 receive 810, from the WTRU, a PDU session establishment request for a DNN with dynamic SSC mode indication and authorizes 815 the PDU session establishment request based on the subscription data for the requested DNN and requested dynamic SSC mode indication. SMF2 retrieves 820 the WTRU's prior serving SMF information (here SMF1) for the requested DNN and receives 825 the SM context from SMF1. SMF2 assigns 830 QoS flows for the requested DNN based on policy and SM context retrieved, which are applicable for the PDU session reallocation and stores mapping with each QoS flow and allowed SSC mode per allowed application at the QoS flow, as SM context. SMF2 sends 835, to the WTRU, a PDU session establishment accept including QoS flows and QoS parameters allowed for the DNN. SMF2 registers 840 SMF2 information as the WTRU's serving SMF for the requested DNN in the UDM.

In various embodiments, WTRUs and methods are disclosed for establishing, with a first network function, a first protocol data unit (PDU) session based on a data network name (DNN) and indication of allowed dynamic session and service continuity (SSC) mode per quality of service (QoS) flow with the DNN. In an example, the WTRU receives, from the first network function, a PDU session modification command for PDU session reallocation of QoS flows for associated SSC modes. The WTRU drops QoS flows associated with SSC mode 2 from the first PDU session and establishes, with a second network function, a second PDU session with QoS flows reallocated from the first PDU session based on the associated SSC modes.

In one example, the QoS flows that are reallocated from the first PDU session to the second PDU session include the QoS flows associated with SSC mode 2 and QoS flows associated with SSC mode 3. In an example, the QoS flows associated with SSC mode 3 are reallocated to the second PDU session prior to dropping the QoS flows associated with SSC mode 3 of the first PDU session.

Similar to previous embodiments, establishing the first PDU session may include sending, to the first network function, a PDU session establishment request for the DNN and an indication of dynamic SSC mode. The WTRU receives, from the first network function, a PDU session establishment accept for the DNN with an indication of allowed dynamic SSC mode per QoS flow for the DNN. The indication of allowed dynamic SSC mode per QoS flow for the DNN may be based on one or more of a subscription for the dynamic SSC mode(s) and/or a SSC mode selection policy provisioned to the WTRU. In an example, the first network function and the second network function are session management functions (SMFs) respectively, and the communications between the WTRU and the respective SMFs may or may not be facilitated through an access and mobility management function (AMF).

In an example, the first PDU session is released when QoS flows associated with SSC mode 1 and SSC mode 3 are released. In an example, dropping the QoS flows associated with SSC mode 2 is based on indication in the PDU session modification command, and the WTRU sends a PDU modification complete to the first network function. In an example, the QoS flows associated SSC mode 3 may be dropped from the first PDU session after a period of time from reallocation of the QoS flows associated SSC mode 3 to the second PDU session.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a wireless transmit/receive unit (WTRU), the method comprising:
establishing, with a first network function, a first protocol data unit (PDU) session based on a data network name (DNN) and indication of allowed dynamic session and service continuity (SSC) mode per quality of service (QoS) flow with the DNN;
receiving, from the first network function, a PDU session modification command for reallocation of QoS flows based on associated SSC modes;
dropping QoS flows associated with SSC mode 2 from the first PDU session; and
establishing, with a second network function, a second PDU session with QoS flows reallocated from the first PDU session based on the associated SSC modes.

2. The method of claim 1, wherein the QoS flows reallocated from the first PDU session to the second PDU session include the QoS flows associated with SSC mode 2 and QoS flows associated with SSC mode 3.

3. The method of claim 2, wherein the QoS flows associated with SSC mode 3 are reallocated to the second PDU session prior to dropping the QoS flows associated with SSC mode 3 of the first PDU session.

4. The method of claim 2, further comprising:
dropping, from the first PDU session, the QoS flows associated SSC mode 3 after a period of time from reallocation of the QoS flows associated SSC mode 3 to the second PDU session.

5. The method of claim 1, wherein establishing the first PDU session comprises:
sending, to the first network function, a PDU session establishment request for the DNN and an indication of dynamic SSC mode; and
receiving, from the first network function, a PDU session establishment accept for the DNN with an indication of allowed dynamic SSC mode per QoS flow for the DNN.

6. The method of claim 5, wherein the indication of allowed dynamic SSC mode per QoS flow for the DNN is based on one or more of a subscription for the dynamic SSC mode and/or a SSC mode selection policy provisioned to the WTRU.

7. The method of claim 1, wherein the first network function and the second network function comprise session management functions (SMFs) respectively, and wherein communications between the WTRU and the respective SMFs may or may not be facilitated through an access and mobility management function (AMF).

8. The method of claim 1, further comprising:
releasing the first PDU session when QoS flows associated with SSC mode 1 and SSC mode 3 are released.

9. The method of claim 1, wherein dropping the QoS flows associated with SSC mode 2 is based on the PDU session modification command, and wherein the method further comprises:
sending a PDU modification complete to the first network function.

10. A wireless transmit/receive unit (WTRU) comprising:
a transceiver; and
a processor communicatively coupled to the transceiver, wherein the transceiver and the processor are configured to:
establish, with a first network function, a first protocol data unit (PDU) session based on a data network name (DNN) and indication of allowed dynamic session and service continuity (SSC) mode per quality of service (QoS) flow with the DNN;
receive, from the first network function, a PDU session modification command for reallocation of QoS flows based on associated SSC modes;
drop QoS flows associated with SSC mode 2 from the first PDU session; and
establish, with a second network function, a second PDU session with QoS flows reallocated from the first PDU session based on the associated SSC modes.

11. The WTRU of claim 10, wherein the QoS flows reallocated from the first PDU session to the second PDU session include the QoS flows associated with SSC mode 2 and QoS flows associated with SSC mode 3.

12. The WTRU of claim 11, wherein the QoS flows associated with SSC mode 3 are reallocated to the second PDU session prior to dropping the QoS flows associated with SSC mode 3 of the first PDU session.

13. The WTRU of claim 11, wherein the transceiver and the processor are further configured to:
drop, from the first PDU session, the QoS flows associated SSC mode 3 after a period of time from reallocation of the QoS flows associated SSC mode 3 to the second PDU session.

14. The WTRU of claim 10, wherein establishing the first PDU session comprises the transceiver and the processor further configured to:
send, to the first network function, a PDU session establishment request for the DNN and an indication of dynamic SSC mode; and
receive, from the first network function, a PDU session establishment accept for the DNN with an indication of allowed dynamic SSC mode per QoS flow for the DNN.

15. The WTRU of claim 14, wherein the indication of allowed dynamic SSC mode per QoS flow for the DNN is based on one or more of a subscription for the dynamic SSC mode and/or a SSC mode selection policy provisioned to the WTRU.

16. The WTRU of claim 10, wherein the first network function and the second network function comprise session management functions (SMFs) respectively, and wherein communications between the WTRU and the respective SMFs may or may not be facilitated through an access and mobility management function (AMF).

17. The WTRU of claim 10, wherein the transceiver and processor are further configured to:
release the first PDU session when QoS flows associated with SSC mode 1 and SSC mode 3 are released.

18. The WTRU of claim 10, wherein dropping the QoS flows associated with SSC mode 2 is based on indication in the PDU session modification command, and wherein the transceiver and the processor are further configured to:
send a PDU modification complete to the first network function.
